(19) United States
(12) Patent Application Publication
(10) Pub. No.: US 2015/0308344 A1
(43) Pub. Date: Oct. 29, 2015

(54) COMBINATION FLOW DIVIDER AND BEARING SUPPORT

(71) Applicant: UNITED TECHNOLOGIES CORPORATION, Hartford, CT (US)

(72) Inventors: Tuan David Vo, Middletown, CT (US); Jonathan Ariel Scott, Southington, CT (US)

(21) Appl. No.: 14/650,710

(22) PCT Filed: Dec. 18, 2013
(86) PCT No.: PCT/US13/76168

§ 371 Date: Jun. 9, 2015

Related U.S. Application Data
(60) Provisional application No. 61/747,243, filed on Dec. 29, 2012.

(51) Int. Cl. F02C 7/20; F02C 7/06

(52) U.S. Cl. CPC F02C 7/20; F02C 7/06

(57) ABSTRACT

A gas turbine module comprises a frame, a fairing assembly, and a single-piece combination bearing support element. The fairing assembly extends generally axially through the frame between the outer case and the inner hub. The single-piece combination bearing support element is mounted to the frame radially inward of the frame inner hub. The single-piece bearing support element includes a bearing support ring section, a frame mounting ring disposed around an aft end of the bearing support ring section, and a first flow divider ring section contiguous with a forward end of the bearing support ring section.

### CROSS-REFERENCE TO RELATED APPLICATION(S)

This application claims the benefit of U.S. Provisional Application No. 61/747,243 filed Dec. 29, 2012 for “COMBINATION FLOW DIVIDER AND BEARING SUPPORT” by Tuan David Vo and Jonathan Ariel Scott and PCT Application No. PCT/US13/76168 filed Dec. 18, 2013 for “COMBINATION FLOW DIVIDER AND BEARING SUPPORT” by Tuan David Vo and Jonathan Ariel Scott.

### BACKGROUND

The described subject matter relates generally to gas turbine engines and more specifically to bearing supports for gas turbine engines.

A turbine exhaust case (TEC) for a gas turbine engine includes a number of structural components as well as various hot working fluid flow paths and coolant flow paths. The coolant provides temperature control of structural components exposed to the hot working fluid to maintain integrity and efficiency of the engine. Cooling ducts typically have multiple interconnected segments disposed separately from the support structure. Though separate duct segments allow for more design flexibility, this flexibility comes at the cost of more complex assembly and leakage, which can decrease operating efficiency.

### SUMMARY

A gas turbine module comprises a frame, a fairing assembly, and a single-piece combination bearing support element. The fairing assembly extends generally axially through the frame between the outer case and the inner hub. The single-piece combination bearing support element is mounted to the frame radially inward of the frame inner hub. The single-piece bearing support element includes a bearing support ring section, a frame mounting ring disposed around an aft end of the bearing support ring section, and a first flow divider ring section contiguous with a forward end of the bearing support ring section.

A gas turbine engine bearing support element comprises a generally cylindrical bearing support ring section and a generally frustoconical first flow divider ring section. The bearing support ring section is adapted to mount a bearing compartment to a frame for a gas turbine engine. The generally frustoconical first flow divider ring section is contiguous with a forward end of the bearing support ring section such that the bearing support ring section and the first flow divider ring section are a single piece.

### BRIEF DESCRIPTION OF THE DRAWINGS

FIG. 1 schematically depicts an example gas turbine engine.

FIG. 2 is a detailed cross-section of a gas turbine exhaust section.

FIG. 3A isometrically shows a forward side of an example turbine exhaust case (TEC) for the gas turbine engine shown in FIG. 1.

FIG. 3B is a magnified isometric view of the forward side of the TEC flow divider section shown in FIG. 3A.

FIG. 3C isometrically shows an aft side of the example TEC shown in FIG. 3A.

FIG. 3D is a magnified isometric view of the aft side of the TEC flow divider section shown in FIG. 3C.

FIG. 4 is an exploded view of the TEC flow divider cavity.

FIG. 5A is an isometric view of a forward side of a bearing support element.

FIG. 5B is an isometric view of the aft side of the bearing support element.

FIG. 5C shows a cross-section of the bearing support element taken through line 5C-5C of FIG. 5A.

### DETAILED DESCRIPTION

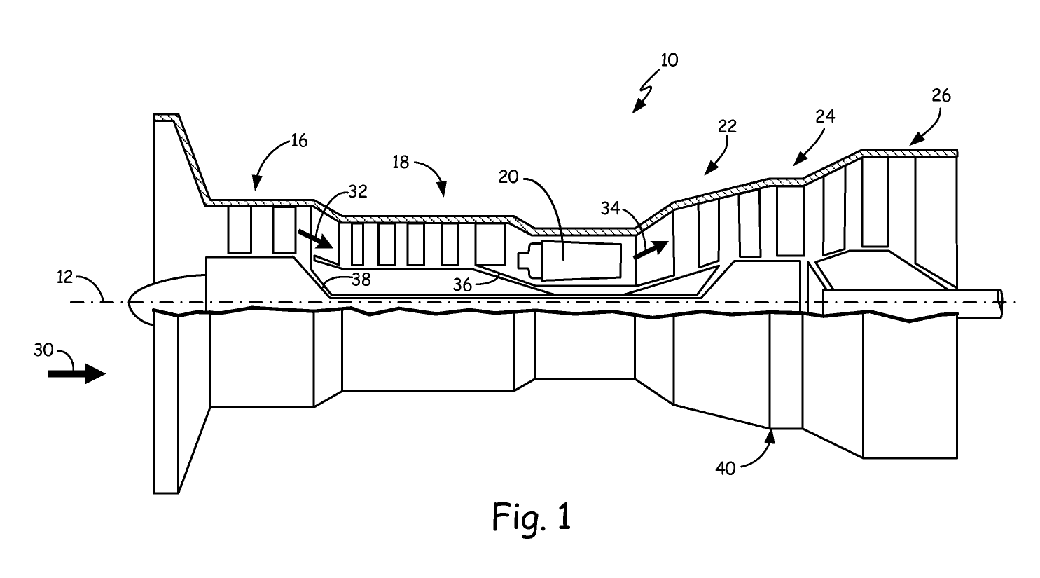

FIG. 1 includes gas turbine engine 10, centerline axis 12, low pressure compressor section 16, high pressure compressor section 18, combustor section 20, high pressure turbine section 22, low pressure turbine section 24, free turbine section 26, incoming ambient air 30, pressurized air 32, combustion gases 34, high pressure rotor shaft 36, low pressure rotor shaft 38, and turbine exhaust case assembly 40.

FIG. 1 shows gas turbine engine 10, which is configured as an industrial gas turbine engine 10 in the illustrated embodiment. Engine 10 is circumferentially disposed about a central, longitudinal axis, or engine centerline axis 12, and includes in series order, low pressure compressor section 16, high pressure compressor section 18, combustor section 20, high pressure turbine section 22, and low pressure turbine section 24. In some examples, a free turbine section 26 is disposed aft of the low pressure turbine 24. Free turbine section 26 is often described as a “power turbine” and can rotationally drive one or more generators, centrifugal pumps, or other apparatuses (not shown).

As is well known in the art of gas turbines, incoming ambient air 30 becomes pressurized air 32 in compressors 16, 18. Fuel mixes with pressurized air 32 in combustor section 20, where it is burned. Once burned, combustion gases 34 expand through turbine sections 22, 24 and power turbine 26. Turbine sections 22 and 24 drive high and low pressure rotor shafts 36 and 38 respectively, which rotate in response to the combustion products and thus the attached compressor sections 18, 16. Free turbine section 26 may, for example, drive an electrical generator, pump, or gearbox (not shown). Turbine exhaust case (TEC) assembly 40 is also shown in FIG. 1, disposed axially between low pressure turbine section 24 and power turbine 26. TEC assembly 40 is described in more detail below.

FIG. 1 provides a basic understanding and overview of the various sections and the basic operation of an industrial gas turbine engine. Although illustrated with reference to an industrial gas turbine engine, the described subject matter also extends to aero engines having a fan with or without a fan speed reduction gearbox, as well as those engines with more or fewer sections than illustrated such as an intermediate pressure spool. It will become apparent to those skilled in the art that the present application is applicable to all types of gas turbine engines, including those in aerospace applications. For example, while the subject matter is described with respect to a TEC assembly for an industrial gas turbine engine, the teachings can be readily adapted to other applications, such as but not limited to a mid-turbine frame and/or turbine exhaust case for an aircraft engine.

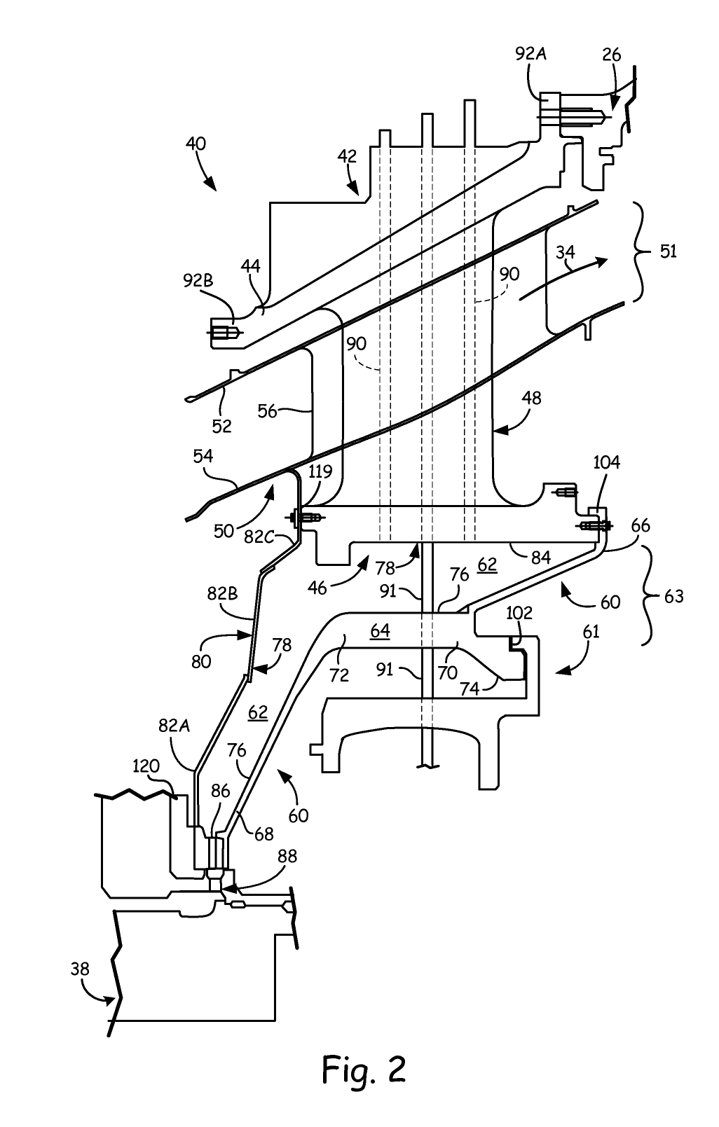

FIG. 2 shows first gas turbine engine module 40, and also shows combustion gases 34, engine shaft 38, frame 42, frame outer case 44, frame inner hub 46, frame strut 48, fairings assembly 50, main engine gas flow path 51, outer platform 52, inner platform 54, liners 56, combination bearing support element 60, bearing compartment 61, flow divider cavity 62, annular gap 63, bearing support ring section 64, frame mounting ring 66, first flow divider ring section 68, bearing support ring section aft end 70, bearing support ring section forward end 72, bearing compartment mounting flange 74, radially inner cavity wall 76, outer cavity wall 78, second flow divider ring 80, metal ring segments 82A, 82B, 82C, TEC frame inner surface 84, inner cooling air ports 86, shaft outlet apertures 88, strut radial passages 90, and service line 91.

As described above, this illustrative example will be described with reference to first module 40 being a TEC assembly, but the described subject matter can be readily adapted for several other gas turbine applications. As seen in FIG. 2, first module 40 includes frame 42 with outer case 44, inner hub 46, with a plurality of circumferentially distributed struts 48 (only one shown in FIG. 2) extending radially between outer case 44 and inner hub 46. Fairing assembly 50 extends generally axially through frame 42 to define main gas flow path 51 for working/combustion gases 34. In this example, fairing assembly 50 includes outer fairing platform 52, inner fairing platform 54, and strut liners 56. TEC assembly 40 may optionally be connected to a downstream module such as a power turbine. The downstream module (e.g., power turbine 26 shown in FIG. 1) can include other components such as a stator vane and rotor blade (not shown in FIG. 2), which are disposed downstream of frame 42 and fairing assembly 50 with respect to the flow direction of working/combustion gases 34.

In the embodiment shown, fairing assembly 50 is affixed to frame 42 and can be adapted to have outer fairing platform 52 disposed radially inward of outer case 44 while inner fairing platform 54 may be disposed radially outward of inner frame hub 46. Strut liners 56 can also be adapted to be disposed around frame struts 48. When assembled, outer fairing platform 52, inner fairing platform 54, and fairing strut liners 56 define a portion of main gas flow path 51 for combustion gases 34 to pass through TEC assembly 40 during engine operation. Main gas flow path 51 can also be sealed (not shown) between gas turbine modules, and around the edges of fairing assembly 50, to reduce unwanted leakage and heating of frame 42.

TEC assembly 40 also includes combination bearing support element 60 which can be a single unitary and monolithic piece operable to secure and transmit loads between TEC frame 42 and bearing compartment 61. Bearing compartment 61 contains a bearing assembly (not shown) to support rotation of shaft 38 about engine centerline 12. Flow divider cavity 62 is disposed in annular gap 63 between bearing compartment 61 and TEC frame 42. Flow divider cavity 62 helps collect, manage, and direct coolant to help maintain desired operating temperatures in, around, and through TEC frame 42. First flow divider ring section 68 can be integral with bearing support ring section 64, such as by joining or forming those parts together using welding, (or other metallurgical joining), as well as by forging, and/or casting. In certain embodiments, combination bearing support element 61 is machined from a single unitary casting.

Combination bearing support element 60 can be mounted to frame 42 radially inward of frame inner hub 46. Combination bearing support element 60 can include bearing support ring section 64, frame mounting ring 66, first flow divider ring section 68, bearing compartment mounting ring 74. Frame mounting ring 66 can be disposed at or near an aft end of bearing support ring section, and first flow divider ring section 68 can be contiguous with forward end 72 of bearing support ring section 64. Together, one or more of these sections of bearing support element 60 can define a contiguous, radially inner wall 76 of flow divider cavity 62.

In this example, combination bearing support element 60 also includes bearing compartment mounting ring 74 with a circumferential flange for securing bearing compartment 61 thereto. Mounting ring 74 may be disposed on bearing support ring aft end 70 to support bearing compartment 61 radially inward of bearing support ring section 64. Frame mounting ring 66 is disposed on a radially outer side of bearing support ring aft end 70 for securing bearing support ring 64 and bearing compartment 61 to TEC frame inner hub 46. Frame mounting ring 66 receives bearing loads from bearing support ring section 64 and transfers them to frame 42 via inner hub 46.

Cavity 62 includes radially inner cavity wall surface 76, which extends between an inner portion of engine 10 (e.g., low spool shaft 38 shown in FIG. 1) and TEC frame inner hub 46. In this example, bearing support ring section 64, first flow divider ring section 68, and frame mounting ring 66 all cooperate to define a continuous inner cavity wall 76 such that inner wall 76 of flow divider cavity 62 extends from shaft 38 to frame inner hub 46.

Outer cavity wall 78 can be defined at least in part by separate second flow divider ring assembly 80 secured axially forward of combination bearing support element 60. Second flow divider ring assembly 80 can include one or more radial ring segments 82A, 82B which can be integrally formed or mechanically interconnected, such as with a snap or interference fit. A radially inner portion of first flow divider ring section 68 can be adapted to receive at least one ring segment 82A, 82B. The ring segment(s) 82A, 82B may be removably secured or fastened to first flow divider ring section 68 proximate a hollow turbine shaft (e.g., low spool shaft 38). The remainder of outer flow divider cavity wall surface 78 can be defined, for example, by inner surface 84 of TEC frame inner hub 46.

In this example, inner cooling air inlet ports 86 are disposed circumferentially around inner ring segment 82A. Inlet parts can be adapted to receive a volume of cooling air from corresponding outlet apertures 88 in rotating shaft 38. Inner coolant inlet ports 86 can be formed through at least one of first flow divider ring section 68 and second flow divider ring 80. Shaft outlet apertures 88 can be circumferentially distributed and radially aligned with flow divider inlet ports 86. In one example, shaft 38 provides air to flow divider cavity 62 across this static/rotational interface of flow divider inlet parts 86 and shaft outlet apertures 88. Flow divider cavity 62 may additionally and/or alternatively receive and transmit cooling air via one or more alternative locations, including but not limited to seal leakage air and/or passages extending through struts 48.

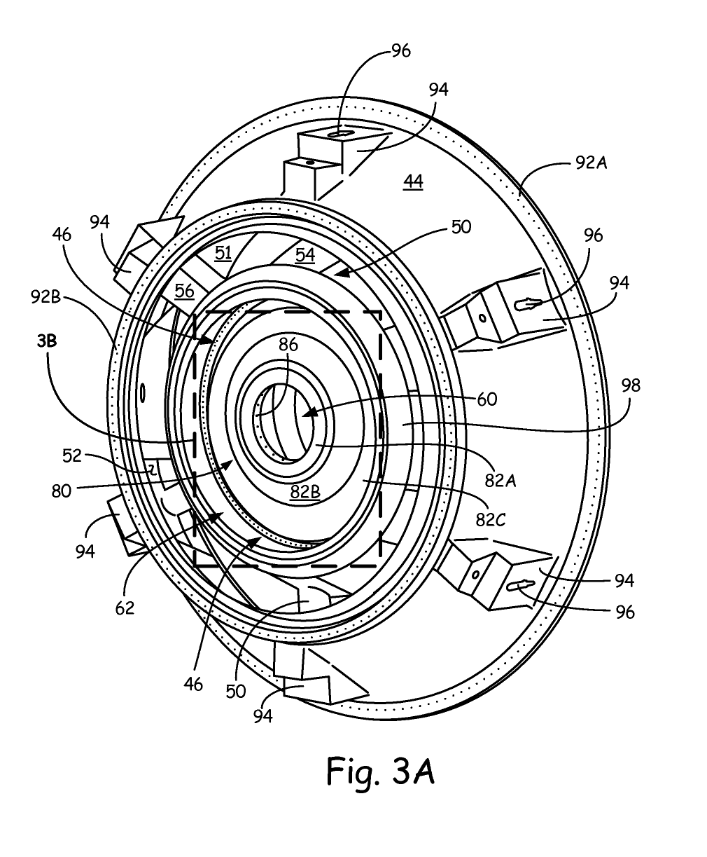

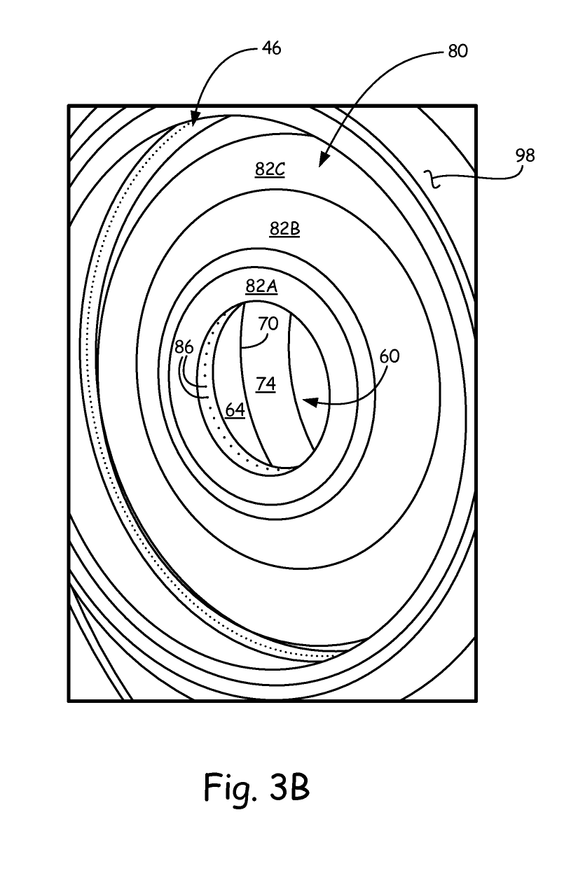

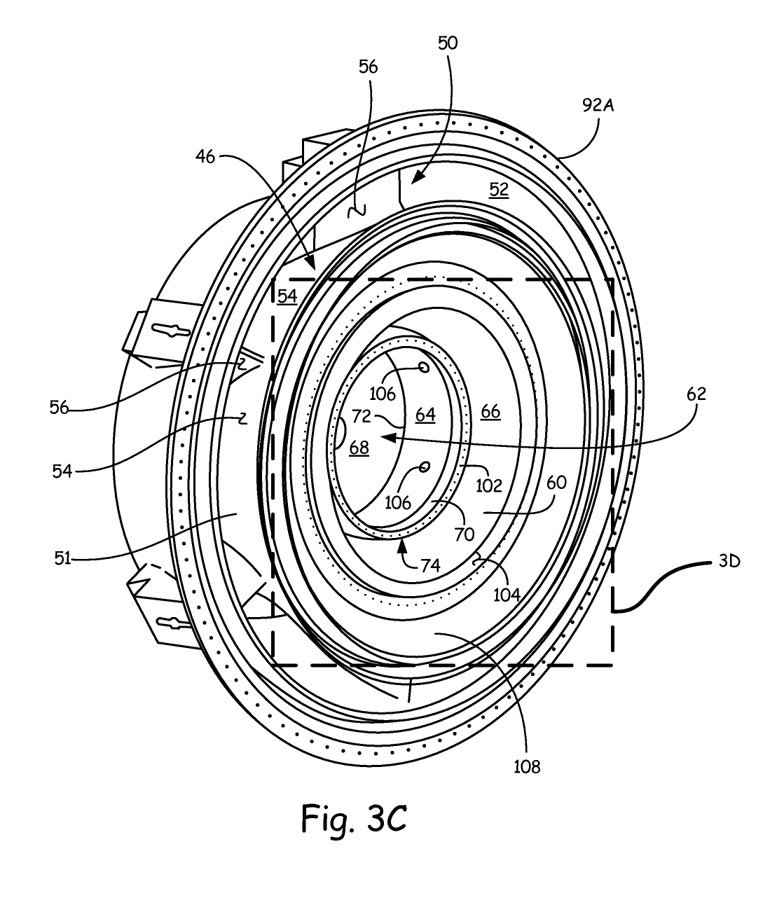

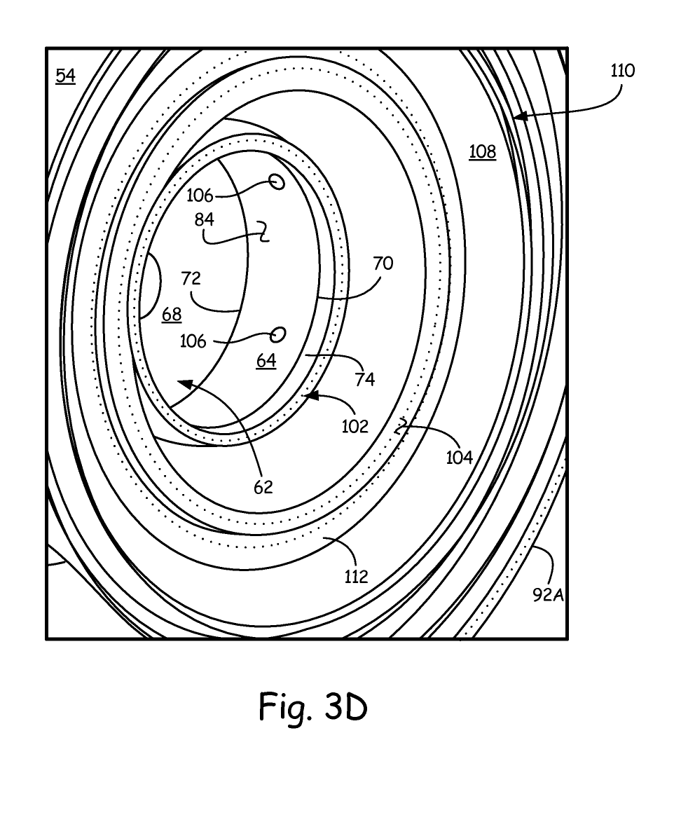

In one example, flow divider cavity 62 can be integrated into a larger cooling scheme to allow use of less expensive structural materials for TEC frame 42. Flow divider cavity 62 can be adapted to receive and direct a volume of cooling air around and through TEC assembly 40. As such, flow divider cavity 62 can include one or more openings (shown in FIGS. 3C and 3D) leading to radially extending passages 90 through frame strut(s) 48. TEC assembly 40 can additionally or alternatively include one or more service lines 91 extending radially through passages 90 and flow divider cavity 62.

FIGS. 3A-3D are multiple isometric views of an example TEC assembly module 40 incorporating a combination bearing support element 60. FIG. 3A shows a forward side of TEC assembly 40, and FIG. 3B is a magnified view of a center portion of FIG. 3A. FIGS. 3A and 3B also include module mounting flanges 92A, 92B, outer strut bosses 94, outer strut bores 96, and forward seal support 98.

As described with respect to FIGS. 1 and 2, TEC assembly 40 has structural TEC frame 42, which includes a plurality of circumferentially distributed struts 48 extending radially between outer case 44 and inner hub 46. Fairings 50 define main gas flow path 51 through TEC assembly 40 and protect struts 48 from direct contact with working/combustion gases 34 (shown in FIGS. 1 and 2).

FIGS. 3A and 3B show various connections for assembling TEC assembly 40 to other modules and components disposed forward and aft of the turbine exhaust case. In the example of FIG. 1, an aft end of TEC assembly 40 can be assembled to power turbine 26 around aft module mounting flange 92A, while a forward end of TEC assembly 40 can be assembled to low pressure turbine 24 around forward module mounting flange 92B. Outer strut bosses 94 provide bores 96 for passage and mounting of service lines and/or service tubes (not shown). These lines and tubes allow cooling air, lubricant, or other fluids to be communicated through passages 90 (shown in FIG. 2) between an inner side and an outer side of frame 42. In this example, optional forward seal support 98 can be secured to inner hub 46 and contribute to sealing main gas flow path 51 around fairings 50. Other seal assemblies (not shown in FIGS. 3A and 3B) can also be used in and around TEC assembly 40 to reduce leakage into various cavities within and between modules.

FIG. 3C shows an aft side of TEC assembly 40, and FIG. 3D is a magnified view of the center portion of FIG. 3C including an aft side of combination bearing support element 60. FIGS. 3C and 3D also include bearing compartment flange mounting interface 102, frame mounting flange 104, ports 106, aft seal support 108, aft seal assembly 110, and aft seal interface 112.

As seen in FIGS. 3C and 3D, combination bearing support element 60 is mounted radially inward of frame inner hub 46 and includes bearing support ring section 64, frame mounting ring 66, and first flow divider ring section 68. Frame mounting ring 66 extends around aft end 70 while first flow divider ring section 68 is contiguous with forward end 72 of bearing support ring section 64.

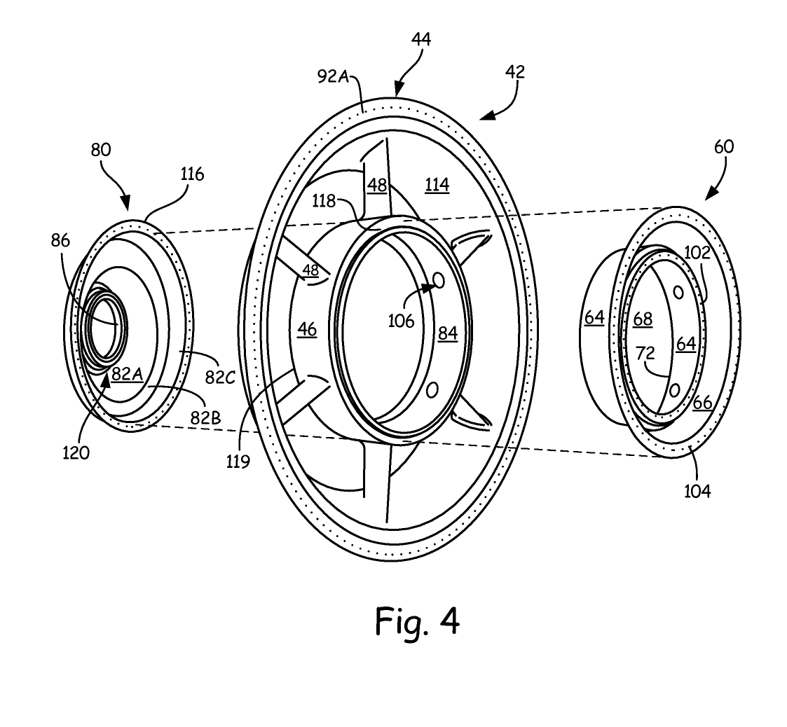

Bearing support ring 64 includes bearing compartment flange 74 with mounting interface 102 for securing and cantilevering bearing compartment 61 as shown in FIG. 2. As seen in FIG. 3D and in FIG. 4, frame mounting ring 66 can include frame mounting flange 104 facing in an opposite direction relative to mounting interface 102. Flange 104 is adapted to secure and suspend bearing support element 60 in a radially inward of frame hub 46. A plurality of openings or apertures 106 can be formed through one or more parts of bearing support element 60. Here, bearing support ring 64 includes circumferentially distributed apertures 106 to allow passage of corresponding service line 91 (shown in FIG. 2) such as oil supply tubes, cooling air supply tubes, and/or scupper lines.

The detailed view of FIG. 3D also shows optional aft seal support 108 and aft seal assembly 110. A radially inner side of aft seal support 108 can be secured to fairing assembly 50 around aft seal interface 112. (e.g. by fasteners and/or as a snap fit).

FIG. 4 is a partially exploded view showing assembly of flow divider cavity, which includes combination bearing support element 60, to frame 42. FIG. 4 also includes frame hub aft end 114, second flow divider ring outer flange 116, frame hub aft end 118, frame hub forward end 119, and second flow divider ring flange 120.

FIG. 4 shows frame mounting flange 104 for securing combination bearing support element 60 to frame hub aft end 118 such that element 60, and more specifically, bearing support ring section 64 can be suspended in a cantilevered fashion radially inward of frame hub 46. FIG. 4 also shows second flow divider ring 80 having an outer end (e.g., outer ring segment 82C) with flange 116 for securing separate second flow divider ring 80 to a corresponding mounting location (shown in FIG. 2) on frame hub forward end 119. A flange 120 of second flow divider ring 80 (e.g., inner segment 82A) can be fastened to a corresponding inner flange (shown in FIG. 2) on first flow divider ring 68. This allows hub inner surface 84 to operate as a portion of flow divider cavity outer wall 78 (shown in FIG. 2). It also provides access to passages 90 (shown in FIG. 2) which may be formed radially through struts 48.

In the example shown, flow divider cavity 62 can receive cooling air via inner inlet port(s) 86, and/or through cooling air passages 90 via openings or apertures 106. The cooling air, which may be any combination of leakage, bleed, and/or used cabin air, is then managed as part of a larger cooling scheme for TEC frame 42 and any other components (e.g., fairings 50, shown in FIG. 2) which are exposed to combustion gases 34 (shown in FIGS. 1 and 2).

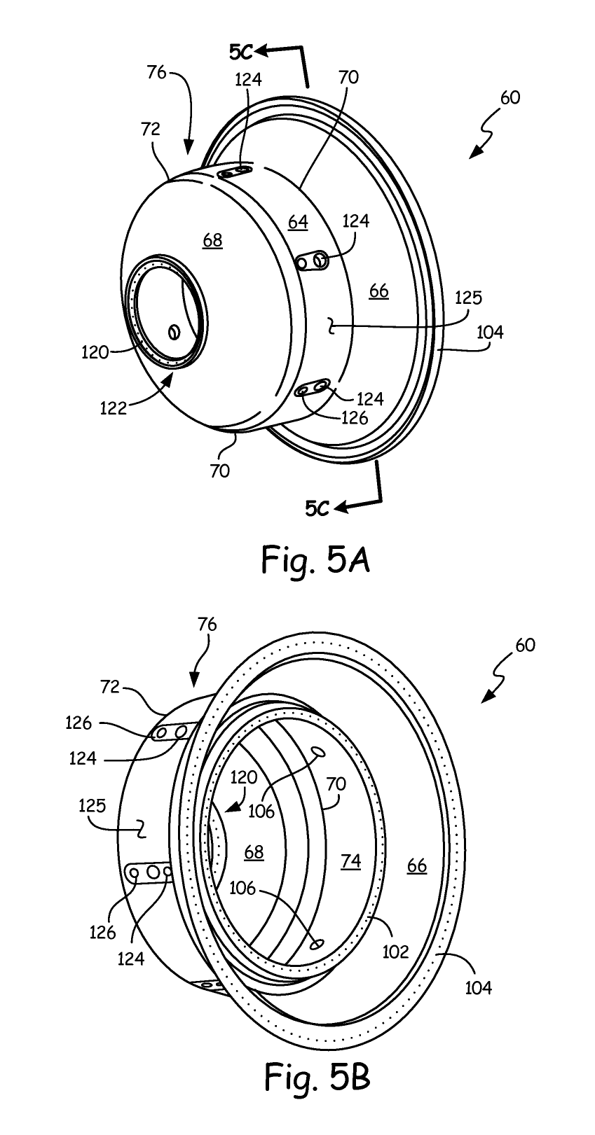

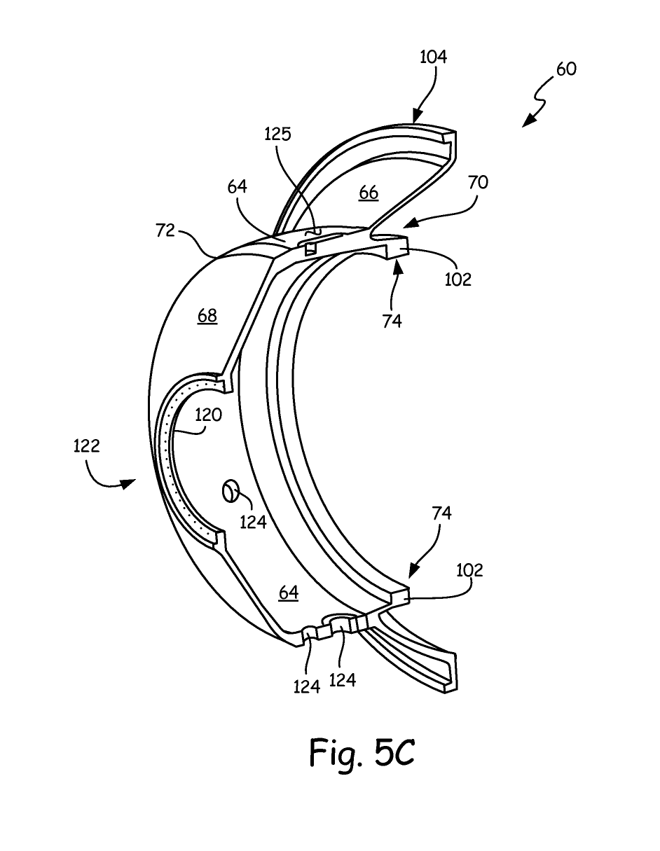

FIG. 5A is an isometric forward view of an example combination bearing support element 60. FIG. 5B is an aft view of the example combination bearing support element 60. FIG. 5C is a cross-section of element 60 taken through line 5C-5C of FIG. 5A. FIGS. 5A-5C also include flow divider ring radially inner portion 122, bearing element ports 124, bearing element outer surface 125, and bearing element recesses 126.

Combination bearing support element 60 includes generally cylindrical bearing support ring section 64 and generally frustoconical first flow divider ring section 68 contiguous with forward end 70 of bearing support ring section 64. Bearing support ring section 64 is provided for mounting bearing compartment (e.g., bearing compartment 61 shown in FIG. 2) to a frame (e.g., frame 42 shown in FIG. 4) for a gas turbine engine.

Frustoconical frame mounting ring 66 extends generally outward from aft end 70 to transfer loads between the frame and bearing support ring section 64. First flow divider ring section 68 can extend generally inward from bearing support ring forward end 72 such that first flow divider ring section 68 and bearing support ring section 64 together provide a contiguous inner boundary wall 76 for flow divider cavity 62 (shown in FIG. 2).

Flow divider ring section 68 includes flange 120 for removably securing at least one flow divider ring component (e.g., second flow divider ring element 82A shown in FIG. 2) to radially inner portion 122. As was also shown in FIG. 2, contiguous inner wall 76 can be adapted to extend generally radially between turbine shaft 38 and frame 42. FIGS. 2-4 show second flow divider ring element 82A with a plurality of inlet ports 86 adapted to receive cooling air. In one example air is provided through the static/rotational interface with shaft outlet ports 88 as shown in FIG. 2. However, inner coolant inlet ports for flow divider cavity 62 can additionally or alternatively be formed through flow divider ring section 68 proximate flange 120.

Bearing compartment mounting flange 74 can be formed around an inner side of bearing support ring aft end 70 for securing and cantilevering bearing compartment 61 as was shown in FIG. 2. In this example, bearing compartment mounting flange 74 is formed as part of bearing support ring 64 by forging, casting, machining, or the like. It will be recognized that different configurations of frame 42 and bearing compartment 61 (shown in FIG. 2) may necessitate some modifications to the relative locations, dimensions, and orientation of combination bearing support element 60 including one or more of bearing support ring section 64, frame mounting ring 66, and first flow divider ring section 68.

To ensure a contiguous flow path, to simplify manufacturing, and reduce leakage, combination bearing support element 60 can thus be cast, forged, or otherwise integrally formed together as a single element. In a casting, bearing support ring section 64, frame mounting ring 66, and first flow divider ring section 68 should begin with a relatively constant radial thickness so as to allow for proper and repeatable solidification. To save weight and simplify machining, combination element 60 can alternatively be hot forged to reduce the initial thicknesses of one or more of the ring sections. Since it is frequently exposed to cooling air, bearing support element 60 is thermally protected and thus may be cast, forged, or otherwise formed from one of a variety of superalloys selected for their castability and/or workability rather than for maximum thermal performance.

Combining the bearing support element ring section 64 with first integral flow divider section 66 into a single piece simplifies manufacturing of element 50. It also reduces leakage and increases stiffness of TEC 40 between shaft 38 and TEC frame 42 due to the need for fewer seams, seals, and fasteners. It also can simplify the geometry and construction of second flow divider ring 66 by more efficiently utilizing limited space that would be otherwise occupied by fasteners or interference fittings needed to interconnect a bearing element ring with a separate flow divider cavity.

FIGS. 5A-5C also show bearing support element ring section 64 with a plurality of ports 124 and recesses 126. These can be adapted to retain or allow passage of cooling air supply tubes or scupper lines. Ports 124 were described previously with respect to FIG. 2 and can optionally be formed through bearing support ring section 64. Recesses 126 can be formed into bearing element outer surface 125 but not entirely through element 60. In certain embodiments, one or more recesses 126 retain and support a cooling air supply tube terminating proximate outer surface 125, through which cooling air can be provided to flow divider cavity 62 (shown in FIG. 2).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A gas turbine module comprising:
a frame including a plurality of circumferentially distributed struts extending radially between an outer case and an inner hub;
a fairing assembly extending generally axially through the frame between the outer case and the inner hub; and
a single-piece combination bearing support element mounted to the frame radially inward of the frame inner hub, the combination bearing support element including a bearing support ring section, a frame mounting ring section disposed around an aft end of the bearing support ring section, and a first flow divider ring section contiguous with a forward end of the bearing support ring section.

2. The gas turbine module of claim 1, further comprising a bearing compartment secured to a bearing compartment mounting flange and supported from an aft end of the bearing support ring section.

3. The gas turbine module of claim 1, further comprising a flow divider cavity disposed in an annular gap between the bearing compartment and the frame inner hub.

4. The gas turbine module of claim 3, wherein the bearing support ring section and first flow divider ring section define a contiguous inner wall surface of the flow divider cavity.

5. The gas turbine module of claim 3, wherein the flow divider cavity includes a separate second flow divider ring assembly forming at least a forward portion of a flow divider cavity outer wall.

6. The gas turbine module of claim 5, wherein the second flow divider ring assembly comprises a plurality of interconnected ring segments.

7. The gas turbine module of claim 5, wherein an inner coolant inlet port is formed through at least one of the first flow divider ring section and the separate second flow divider ring assembly.

8. The gas turbine module of claim 7, wherein the inner coolant inlet port is adapted to receive cooling air ejected from a rotating turbine shaft.

9. The gas turbine module of claim 8, wherein the inner wall of the flow divider cavity extends from the turbine shaft to the frame inner hub.

10. The gas turbine module of claim 1, wherein the flow divider cavity includes an opening leading to a passage extending radially through one of the plurality of frame struts.

11. The gas turbine module of claim 1, wherein the combination bearing support element is formed from a single casting.

12. The gas turbine module of claim 1, wherein the module comprises a turbine exhaust case (TEC) assembly.

13. A bearing support element for a gas turbine engine, the bearing support element comprising:
a generally cylindrical bearing support ring section for mounting a bearing compartment to a frame for a gas turbine engine; and
a generally frustoconical first flow divider ring section contiguous with a forward end of the bearing support ring section, the bearing support ring section and the first flow divider ring section being a single piece.

14. The bearing support element of claim 13, further comprising a bearing compartment flange disposed at an aft end of the bearing support ring section for securing and supporting a bearing compartment radially inward of the bearing support ring section

15. The bearing support element of claim 13, further comprising a frame mounting flange disposed circumferentially around an aft end of the bearing support ring section for securing and supporting the combination bearing support element from an aft end of an engine frame.

16. The bearing support element of claim 13, wherein the bearing support ring section and first flow divider ring section define a contiguous inner wall surface of a flow divider cavity.

17. The bearing support element of claim 16, wherein the contiguous inner wall surface is adapted to extend generally radially between a turbine shaft and the engine frame.

18. The bearing support element of claim 16, wherein the flow divider ring section includes a flange for removably securing at least one second flow divider ring component to a radially inner portion of the first flow divider ring portion.

19. The bearing support element of claim 17, wherein an inner coolant inlet port is formed through at least one of the first flow divider ring section and the second flow divider ring component.

20. The bearing support element of claim 19, wherein the inner coolant inlet port is adapted to receive cooling air ejected from the turbine shaft.
